(19) United States
(12) Patent Application Publication
(10) Pub. No.: US 2012/0084158 A1
(43) Pub. Date: Apr. 5, 2012

(54) SYSTEM AND METHOD FOR PROVIDING COMMUNICATIONS

(75) Inventors: Timo AHOPELTO, Helsinki (FI); Ilkka TEPPO, Espoo (FI); Jouni MALINEN, Espoo (FI)

(73) Assignee: CVON INNOVATIONS LTD, LONDON (GB)

(21) Appl. No.: 12/985,866

(22) Filed: Jan. 6, 2011

Related U.S. Application Data
(63) Continuation of application No. PCT/EP2009/067775, filed on Dec. 22, 2009.

(30) Foreign Application Priority Data
Dec. 22, 2008 (GB) 0823323.1

(51) Int. Cl. G06Q 30/02; G06F 15/16; G06F 17/30

(52) U.S. Cl. 705/14.71; 707/769; 709/206; 707/E17.014

(57) ABSTRACT

Embodiments of the system and method for providing communications are concerned with addressing a relevant communication to a recipient based on a message received from the recipient. At least one term of the message is compared to content keywords and a message content is selected for delivery based on a match between the term and a content keyword.

This is a continuation Application of International Application No. PCT/EP2009/067775, filed on Dec. 22, 2009, which claimed the priority of Great Britain Application No. 0823323.1, filed Dec. 22, 2008, the entire content of each of which applications are hereby incorporated by reference.

### FIELD OF THE INVENTION

The present invention relates to a system and method for selecting message content for a recipient based on a message received from the recipient.

### BACKGROUND OF THE INVENTION

Many information services are configured to send message content to subscribers based on preset criteria depending on content type and target audience via the Short Messaging Service (SMS), by e-mail and/or via the Multimedia Messaging Service (MMS). Criteria of sent content type can be set by the content provider or it can be set by recipient of the content such as consumer or subscriber. An example of content type is promotional content where the content type is defined by party providing service of delivering promotional content and the recipients for the content are selected typically based on profiles and/or interests of recipients.

A particular problem is experienced in the process of selecting appropriate content for recipients. Often profiles of recipients do not represent the reality of consumer preferences as those might change rapidly or the preferences might depend on the context. This might lead to situation where the content service provider might not find right recipients or sufficient amount of recipients for the messages or message content might be delivered to recipients that do not appreciate the content.

### SUMMARY OF THE INVENTION

In accordance with at least one embodiment of the invention, methods, systems and software are provided for supporting or implementing functionality to provide selection of message content for a recipient based on a message received from the recipient, as specified in the independent claims. This is achieved by a combination of features recited in each independent claim. Accordingly, dependent claims prescribe further detailed implementations of the present invention.

More particularly, aspects of the invention provide a method for selecting message content for a recipient based on a message received from the recipient, the method comprising:

receiving a message from a recipient, the message comprising at least one term;

selecting at least one of the terms in the message as a keyword;

comparing the selected keyword to content keywords in a content keyword database, the content keyword database comprising plurality of content keywords, to select at least one content keyword matching to the selected keyword as a matching content keyword;

searching if any message content stored to a content database has a content keyword associated with it that is same than the matching content keyword and/or same than a content keyword in connection to the matching keyword, the content database comprising plurality of message contents of which at least one message content is associated with at least one content keyword; and

selecting for delivery to the recipient a message content of which associated content keyword is the same than the matching content keyword and/or same than a content keyword in connection to the matching keyword.

In some embodiments of the invention, at least some of the message content has a set bid amount, and message content is selected using the set bid amount as a selection criteria.

In some embodiments of the invention, message content is associated with a content keyword by selecting at least one content keyword from plurality of predetermined content keywords. The predetermined content keywords may be arranged to a hierarchical structure to at least two levels. According to at least one embodiment of the invention, the hierarchical structure is a hierarchical tree structure comprising at least one main level and at least one sub-level.

In some embodiments of the invention, content keywords may be connected to another content keyword and such a connection may exist when a first content keyword is subordinate of a second keyword.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a schematic diagram showing an environment in which a embodiment of the invention can operate;

FIG. 2 is a schematic block diagram showing components of a content delivery platform according to an embodiment of the invention;

FIG. 3 is a schematic flow diagram showing some steps in embodiments;

FIG. 4 is a schematic flow diagram showing some message flow in embodiments;

FIG. 5 is a schematic flow diagram showing exemplary steps of an embodiment of the invention;

FIG. 6 is a schematic flow diagram showing message content selection according to an embodiment of the invention; and

FIG. 7 is a schematic example of message content and question categories.

### DETAILED DESCRIPTION OF THE INVENTION

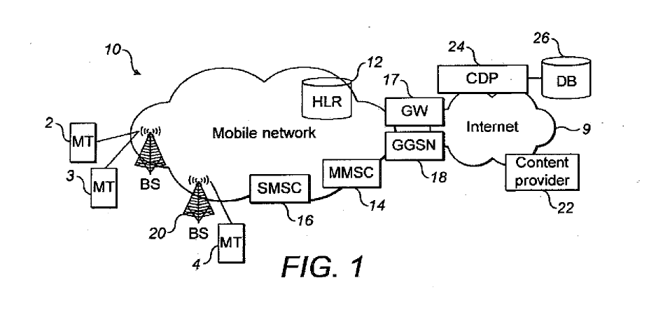

As described above, embodiments of the invention are concerned with improving efficiency of selection of message content for a recipient. An example embodiments are related on providing Multimedia Message Service (MMS) or Short Message Service (SMS) messages to recipients. Typically embodiments of the invention would be applicable to subscribers of a mobile communications network 10 shown in FIG. 1. An exemplifying arrangement of the associate network components will now be described, by way of an introduction to embodiments of the invention.

The mobile network 10 can be any cellular, broadcast, wide area network. Examples of cellular network technologies include but are not limited to GSM (Global System for Mobile communication), WCDMA (Wideband CDMA), CDMA (Code Division Multiple Access), GPRS (General Packet Radio Service), UTRAN (UMTS Radio Access Network), UMTS (Universal Mobile Telecommunications System), MBMS (Multicast Broadcast Multimedia System). Examples of other network technologies include but are not limited to local area networks, such as Wireless Local area networks (WLAN), BlueTooth (BT), and other technologies, such as WiMax (Worldwide Interoperability for Microwave Access), Broadcasting over cellular, Broadcasting over DVB-H (Digital Video Broadcasting-Handhelds), ISDB-T (Terrestrial Integrated Services Digital Broadcasting), DMB (Digital Multimedia Broadcasting). The communication network 10 may also be connected to a public switched telephone network (not shown) and can provide generic Internet access using any transport methods. The communications network can consists of several technologies forming so called hybrid networks.

The exemplary GSM, GPRS communications network 10 of FIG. 1 comprises a radio access domain with for example radio base stations 20 for wireless transmission and reception of data, communications and messages from/to mobile terminals 2, 3 and 4. In addition to the network 10 comprises elements such as home location register (HLR) 12, which is a database subscriber authentication data, switching components (not shown, but commonly referred as MSC, and visitor location register (VLR). Subscribers of mobile communication network 10 may originate or receive multimedia, video, voice, data calls or sessions, short messages using Short Message Service (SMS) via Short Message Service Centre 16 SMSC, enhanced or Multimedia Message Service (MMS) messages via Multimedia Message Service Centre MMSC 14. Further more the user may access data and multimedia resources such as Wireless Application Protocol (WAP) or Web pages over private or public data networks such as the Internet 9.

Mobile communication network 10 can be connected to Internet via Gateway (GW) system 17 comprising one or more connectivity means depending on need. Gateway 17 can be for example for providing access to Wireless Application Protocol services in which case Gateway 17 could consist WAP gateway. For Internet access to subscribers there can be for example Gateway GPRS Service Node 18 that connects communication network 10 with Internet 9.

The mobile terminals 2, 4 may be a mobile phone, a personal digital assistant (PDA), a multimedia computer, a personal computer, a lap top, etc., or generally any terminal capable of accessing services, such as content download, web browsing, streaming, Wireless Application Protocol (WAP) browsing, Internet browsing voice and messaging. In the case of the mobile network 10 being embodied as a GSM, GPRS or WCDMA network, the terminal is a mobile phone with associated GSM, GPRS or WCDMA functionalities. While FIG. 1 shows three terminals: 2, 3, 4, embodiments of the invention can be used to situations with more terminals.

As stated above, embodiments of the inventions are concerned with addressing communication to recipient. Referring again to FIG. 1, in embodiments of the inventions, such addressing and/or delivery is controlled mainly by means of Content Delivery Platform (CDP) 24 comprising of user and/or content database 26. CDP 24 might comprise additionally one or more of following: a Central Processing Unit (CPU), a memory 240, an Interactive Response Service module 242, a Question Engine 244, a Keyword Mapper 246 which may comprise a content keyword database, and a Messaging Engine 248.

Content Provider 22 can have access to CDP 24 via Web interface or similar in order to configure CDP to deliver communication to target addresses. The message content can be delivered to users via elements in communication network 10 such as SMSC 16 and MMSC 14. Content provider 22 can be for example new service provider, entertainment service provider or provider of promotional content (e.g. Advertiser). Delivered message content can be in form of SMS, MMS etc consisting of voice, pictures, videos, data, text, coupons etc. Message content might include links such as Uniform Resource Locators (URL's) to enable users (with mobile terminals 2, 3, 4) to access more information via means of Web or WAP browsing via GW 17 or GGSN 18.

Database 26 can be populated with profiles and preferences of subscribers of Mobile communication network 10. Such profiles and preferences can be for example demographic information, age, gender, likes/dislikes, information about purchasing behaviour etc. Database 26 might also store communications indented for recipients as well as preference by content provider 22 of when and to which type of recipients to send the communications.

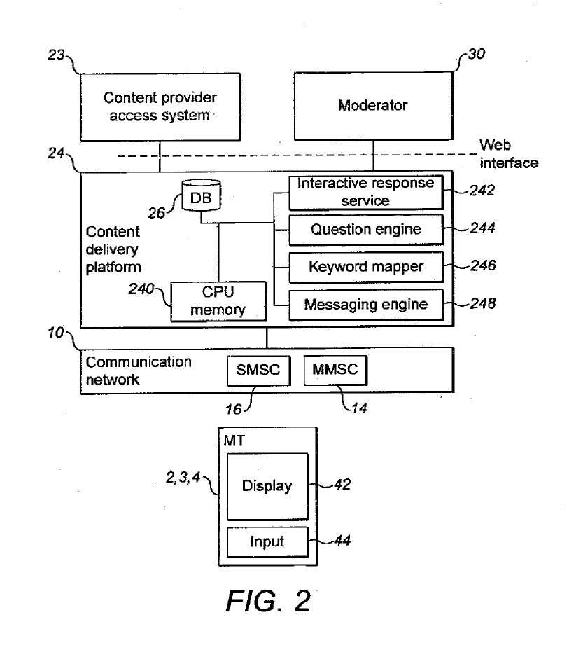

At least one embodiment of the invention can be used to implement an advertisement delivery system. Such an embodiment is described more detailed in FIG. 2. Content provider (Advertiser) 22 can use Content provider access system 23 to access Content Delivery Platform 24 for example via web interface or similar. Advertiser might use the interface to book Advertisement campaign, submit material for advertisements, set rules and biddings for the advertisements, define content keywords for the triggering of sending the advertisements, and for bidding for the content keywords related to selecting of advertisements. Campaign parameters might be stored in Database (DB) 26 of CDP 24. The Content Delivery Platform 24 can further analyse input from subscribers, such as answers to sent earlier questions, to select suitable questions to be sent to subscriber using keyword matching algorithm and bids.

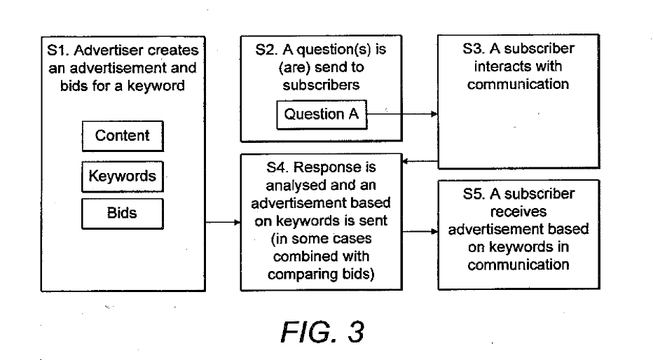

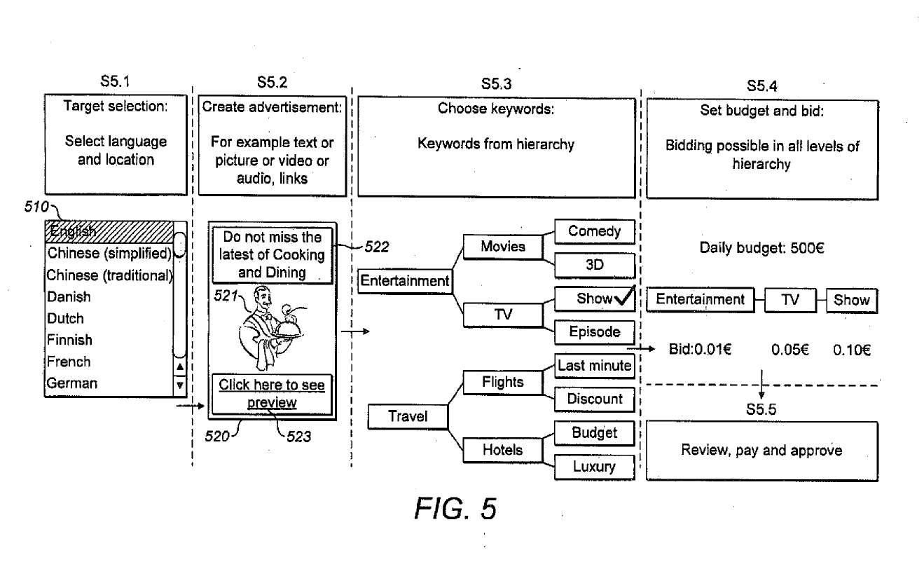

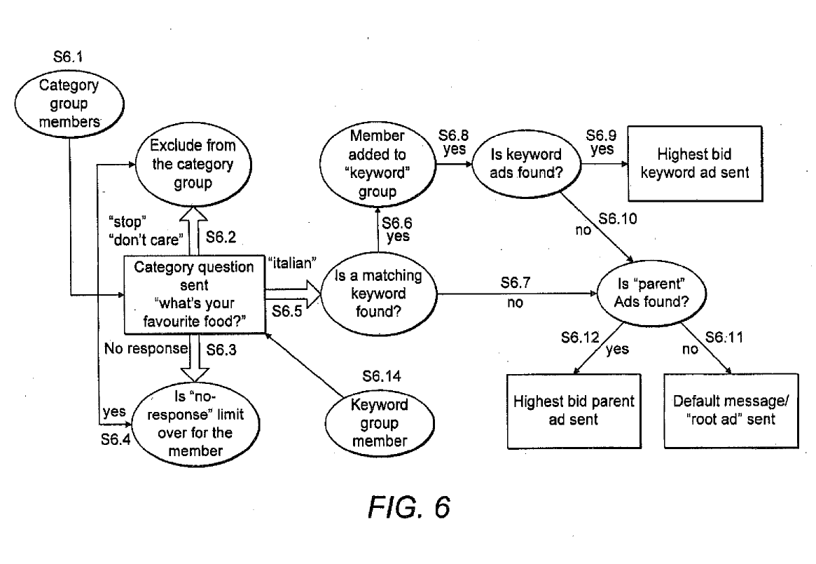

High level steps of an embodiment of the invention is presented in FIG. 3. In step S1 advertiser creates a message content, such as an advertisement, and uploads it to system. In addition the advertiser can associate in this step advertisement to one or more content keywords. Advertiser might also set bids for content keywords that are associated with the message content, such as advertisements. The step S1 is described in more detail in connection to FIGS. 5 and 6 described below.

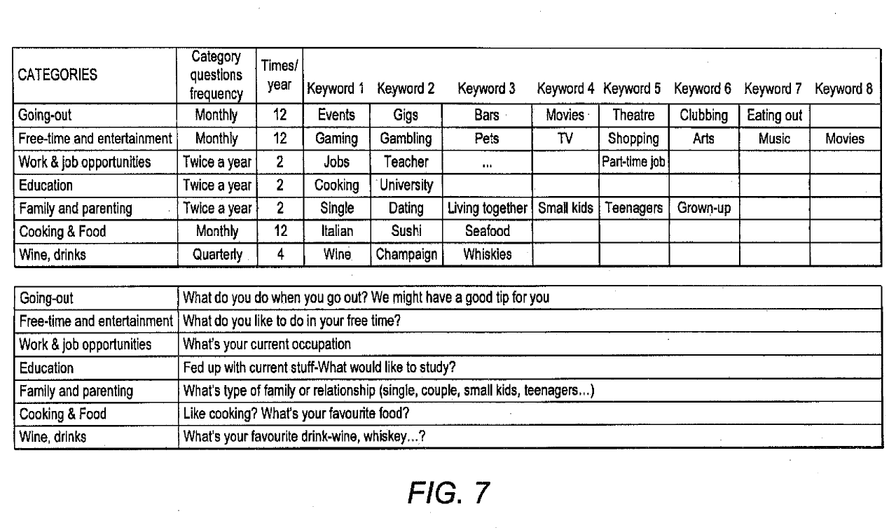

Step S2 can be independent process from S1. In S2 operator of advertisement service sends triggering questions to subscribers of the communication system. Triggering questions can be addressed based on profiles, based on advertisement inventory or some other criteria. Example questions are shown in FIG. 7 in the lower table.

In S3 subscriber interacts with received communication. Interaction can be for example answering to question with SMS. Response can be sent to specific number (such as same number that the question was received) or there can be different number for reply than sending. In step S4 response from subscriber is analysed. Analysis refers on looking on terms in the response and comparing those with keywords in database. More detailed embodiment of the analysis is explained later. As a result from the analysis of the terms in answer to set of keywords one or more matching advertisements might be found. In case of more than one matching advertisement is found the one with highest bid might be selected for delivery to subscriber.

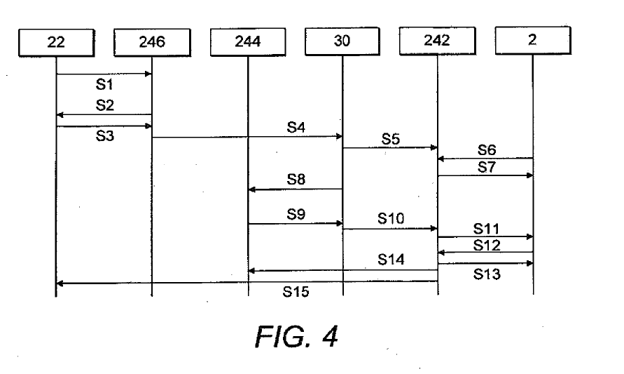

FIG. 4 describes of message flows according to some embodiments of invention. In S1 advertiser uploads advertisements to system and can sets bids for content keywords. Uploading of advertisement and setting of bids do not have to take place in during same session and association of a message, e.g. an advertisement, with a content keyword may be set also additionally or alternatively during a process of setting a campaign based on earlier updated message content or message content may be uploaded after a content keyword is associated with to be uploaded message content. Keyword Mapper 246 shows for advertiser 22 some question candidates for content keyword(s) to demonstrate what kind of questions said keywords could be associated with. As an example advertiser could be shown a set of questions like “Do you like gaming?”, “PC or console?”, “Nintendo™ or PS™?”. Advertiser 22 might change content keywords to look for appropriate question candidates. When the content keyword and biddings are confirmed to Keyword Mapper 246 in S3, keyword Mapper 246 sends ad for moderator 30 with content keywords. Moderator 30 approves (or disapproves) ads and keywords either manually, based on programmed rule set or automatically. For example set of forbidden keywords can relate to blocking keywords with registered trademarks that are not allowed to be used by said advertiser. Approved advertisement and related content keywords are uploaded to Interactive Response Service module 242 in step 5.

User sends a message to system as response to question (sending of question is not shown) in step 6. Without limiting scope of the invention the message does not necessarily have to be in connection with sent question from 24 it can also be any other communication related message that is analysed. The message keywords are analysed in Interactive Response Service module 242 and associated advertisement is send based on keywords to subscriber 2 (3, 4) in S7. Sending of advertisement can be close to communication or it can be done in scheduled time or it can be sent at random time after the communication.

One of the roles of Moderator 30 can be creating new questions and sending those to subscribers in order to activate retrieval of words and terms that can be used as keywords (as reply from subscribers). For example in step 8 Moderator 30 can get question templates related to one or more keywords for creating actual questions for subscribers. Question engine 244 might consist and provide Moderator (step 9) for example questions templates that are ranked on response rate and frequency. As an example of ranking of question templates is response rate per send question or word distribution of received answers or response time of send question type. Questions can be sorted based on the measured rank.

The questions can be targeted optionally to arbitrary subscribers or to subscribers with certain profiles or history (S10). New questions are send to one or more subscribers in step 11. Questions might be same for all, depending on the group, those can be individual, depending on location of the subscriber, depend on history of subscriber. As the subscriber responses to question(s) in step 12 Interactive Response Server selects associated advertisement to subscriber and sends it in step 13. The ad can be same as sent before or there can be set of rules that determine number of ads same or related ads to be sent for a subscriber. Since embodiments of the invention enable triggering of sending advertisement when subscriber sends any communication to Content Delivery Platform 24 the subscriber might answer same question multiple times or subscriber might send message without any question. Depending on the settings advertisement might be sent to user every time any communication is received or it might be limited for example only to be associated with sent question answer pairs.

Interactive Response Service 242 updates response rate, frequency and keywords in question to Question Engine 244 for further processing and analyse. Interactive Response Service 242 also sends to advertiser 22 contact results.

Additional embodiment of using invention is described in steps of FIG. 5. In step 5.1 advertiser selects language and location of the target customers via web interface to content delivery platform 24. For example the user interface might contain scroll menu 510 for selecting language with for example mouse or similar of remote terminal used by advertiser. Remote terminal can be for example personal computer PC. In next step S5.2 advertiser creates and/or uploads advertisement for target mobile terminals. An example advertisement as it would be rendered in the terminal is shown as 520 with elements like text 522, picture 521 and user selectable link 523 to be used for example on finding more on the advertisement like video or web page. In step S5.3 advertiser can be shown via web interface plurality of predetermined content keyword arranged hierarchically. Advertiser can use for example mouse to select target content keyword(s) in hierarchy or hierarchies. In this example advertiser has selected content keyword “show” in entertainment/TV hierarchy tree. The selected content keyword “show” is connected to content keyword “TV”, i.e. content keyword “show” is subordinate of the content keyword “TV”. In step S5.4 advertiser can set bids for the selected keyword and hierarchy. There can be for example maximum bid for the daily budget (like maximum 500ε/day) in addition there can be bids for different levels of hierarchy. For example advertiser might bid 0.01ε for entertainment, 0.05ε for TV and 0.1ε for “show” as in FIG. 5. Finally in the step S5.5 advertiser can review, approve the campaign and pay. Payment can be done via for example secured connection using credit card. Additionally or alternatively advertisers might have account in the system that can be used. Additionally or alternatively advertisers can be invoiced later.

Additionally, at least in some embodiments of the invention, a set budget amount defines a fund amount, and the fund amount is reduced by a set bid amount, or by an amount that is second highest bid amount+a set increment, when a message content is selected for delivery. In such an embodiments, a message content is selected for delivery typically only if remaining fund amount is bigger than the set bid amount.

FIG. 6 shows some steps in embodiment of how content delivery platform 24 might operate. In step 6.1 it is assumed that subscriber can belong to any category (such as entertainment, food, travel etc). In step S6.2 a category determination question might be sent to subscriber via for example SMS from question engine 244. As an example question can be “What is your favourite food”. If there is no response the amount of non responses can be analysed in S6.4. If set threshold is exceeded the subscriber might be marked in database 26 as excluded from the category. Additionally if subscriber indicates that he/she is not interested in said category with message such “stop”, “I don't care” subscriber might be excluded from the category as in S6.2.

In case subscriber answers to sent question for example “Italian” in step S6.5 keyword mapping functionality in keyword mapper 246 might be initiated. If keyword is found (s6.6) member might be added to category group of said keyword or question. If there is advertisement, i.e. message content, associated with the content keyword, highest bid advertisement is sent to subscriber in S6.9 by messaging engine 248. If no keywords are found in step S6.10 the existence of “parent” ad is studied in content delivery platform 24. At least in some embodiments, parent ad is an ad that is that is connected to “child” ad, i.e. parent ad and child ad are arranged hierarchically in such away that child ad is subordinate of the parent ad. Similarly if no matching keyword is found parent ad is studied S6.7. If there is advertisement in higher hierarchy the highest bid advertisement is sent in S6.12 if no then for example some default message or some other message might be sent in S6.11. Further if keyword category is known the question engine 244 might send related ads to subscribers in certain category as in S6.14. Alternatively, in some embodiments message content, e.g. an ad, will be sent which has the lowest bid amount set.

At least in one embodiment of the present invention, plurality of message contents has found to be associated with a content keyword that is the same than the matching content keyword and/or same than a content keyword in connection to the matching keyword, a message content having associated with the same content keyword than the matching keyword is selected for delivery.

Example of categories and related keywords and example questions is shown in table of FIG. 7. The categories, keywords and questions can be stored in database 26. There might be additionally rules in question engine that certain category questions are asked by determined frequency such as monthly, every week etc as shown in table of FIG. 7. In addition there might be rules in the system that there is only certain amount of category questions or other questions per time period such as day, week, month, year and different categories might rotate so that first is category 1 then 2 etc. Keywords are referred to be connected if they belong in same category, for example “Event”, “Gigs” “Bars” are connected to category “Going-Out”.

As an “use case” example of an embodiment of the invention there might be two advertisers, i.e. advertiser 1 and 2. Advertiser 1 has two active campaigns “Drinks” and “Movie”. Both campaigns of Advertiser 1 have one advertisement associated with them namely “Cola” and “Trailer 1”. Advertiser 1 has given a bid of 0.3ε for content keyword “Drink”. The “Drink” keyword is associated with “Cola” ad of “Drinks” Campaign.

Alternatively content keyword “Drink” can be associated with keyword Category of “Soft drinks” or “Cola” ad can be associated with Category hierarchy of “Soft drinks” and/or “Drinking” and/or “Food” depending on setup of database structure.

| Advertiser | Category | Campaign | Ad | Bid | Keywords |
|---|---|---|---|---|---|
| 1 | Soft Drinks | Drinks | Cola | 0.3 [symbol] | Drink |
| 1 | Entertainment | Movie | Trailer 1 | 0.25 [symbol] | Movie, |
| | | | | 0.1 [symbol] | going out |
| 2 | Movie | Movie | Discount | 0.27 [symbol] | Movie |
| | | promo | | 0.15 [symbol] | Tickets |
| 2 | Entertainment | Movie | Trailer 2 | 0.4 [symbol] | Watch |
| | | promo | | | trailer |

In the example there is bid of “0.25ε” for content keyword “Movie” and 0.1ε for content keyword “going out” for campaign “Movie” and advertisement “Trailer 1”. Actual ads “Cola” could be for example MMS message with Coca Cola™ logo and “Trailer 1” could be for example MMS video message with movie trailer of the advertised movie. Advertiser 2 has one campaign “Movie promo” active. There are two different advertisements associated with campaign “Discount” and “Trailer 2”. Advertiser has set bid of 0.27ε for content keyword “Movie” and 0.15ε for content keyword “Tickets” that are associated with “Discount” advertisement. The advertiser has bid for content keyword phrase “Watch trailer” with 0.4ε and associated ad “Trailer 2” for the said content keyword. Actual advertisement of “Discount” could be for example coupon giving 10% off the price of movie ticket. Trailer 2 could be for example video sent over MMS or for example link to video streaming service showing the trailer of the video

The operator of the system sends questions to subscribers like: “Bored-what's your plans for the weekend” or “Want to know todays TV shows, Movies or Bars?”. The subscriber reads the messages and answers to one of those “Planning to watch movie on TV”. The response is analysed in keyword mapper module 246. Based on the response or history of responses associated advertisement is selected from database 26 and further send to subscriber. Selection is done by mapping terms that can be used as keywords in the response to content keywords set by the advertiser.

Since keywords “Watch” and “Movie” were found in communication the system finds at least advertisements Trailer 1 of Advertiser 1 and Discount and Trailer 2 for Advertiser 2. Trailer 2 has the highest bid (0.4ε) on found advertisements. Trailer 2 of Advertiser 2 is sent to subscriber if the daily budget of advertiser 2 has not been spent. 0.4ε of the budget is reduced after delivering or sending the advertisement.

According to at least one embodiment of the invention, message content is selected for a recipient by selecting at least one term contained in a message as a keyword and comparing the selected keyword to content keywords in a content keyword database comprising plurality of content keywords, to select at least one content keyword matching to the selected keyword as a matching content keyword. The matching content keyword is then used to search if any message content stored to a content database has a content keyword associated with it that is same than the matching content keyword and/or same than a content keyword in connection to the matching keyword. A message content of which associated content keyword is the same than the matching content keyword and/or same than a content keyword in connection to the matching keyword is selected for delivery to the recipient.

According to some embodiments, the selected message, i.e. message content, is sent to the recipient as a message, e.g. as a Short Messaging System (SMS) message or as a Multimedia Messaging System (MMS) message.

The above embodiments are to be understood as illustrative examples of the invention. Further embodiments of the invention are envisaged. For example, one embodiment could be to use received keywords to trigger sending of entertainment content to subscriber.

Since the answers are free word answers the answers can be anything As an example question: “How much are you planning to spend on Christmas presents this year? 1) More than last year; 2) The same as last year; 3) Less than last year. ̂1/2/3” was answered by about 5000 subscribers and hundredths of different answers was received. In the list below is presented some of the answers and number of answers of the type. In conventional systems expected answers would be either 1, 2 or 3 and possible analysis of the results would be based on those. Out of 5000 answers only 681+671+389=1741 answers would be used and rest (5000−1741=3259) discarded leading efficiently to waste of communication resources.

| | |
|---|---|
| 1 | 681 |
| 3 | 671 |
| B | 565 |
| A | 530 |
| 2 | 389 |
| C | 234 |
| D | 80 |
| Laptop | 51 |
| PS3 | 43 |
| Clothes | 39 |
| Xbox | 360 |
| Car | 30 |
| Drink | 28 |
| Ipod | 28 |

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method for selecting message content for a recipient based on a message received from the recipient, comprising:
receiving a message from a recipient, the message comprising at least one term;
selecting at least one of the terms in the message as a keyword;
comparing the selected keyword to content keywords in a content keyword database, the content keyword database comprising plurality of content keywords, to select at least one content keyword matching to the selected keyword as a matching content keyword;
searching if any message content stored to a content database has a content keyword associated with it that is same than the matching content keyword and/or same than a content keyword in connection to the matching keyword, the content database comprising plurality of message contents of which at least one message content is associated with at least one content keyword; and
selecting for delivery to the recipient a message content of which associated content keyword is the same than the matching content keyword and/or same than a content keyword in connection to the matching keyword.

2. The method of claim 1, wherein the selected message content is sent to the recipient as a message.

3. The method of claim 2, wherein the selected message is sent to the recipient as a Short Messaging System (SMS) message.

4. The method of claim 2, wherein the selected message is sent to the recipient as a Multimedia Messaging System (MMS) message

5. The method of claim 1, wherein the message received from the recipient is received as a response to a question sent to the recipient.

6. The method of claim 1, wherein at least some of the message content has a set bid amount, and message content is selected using the set bid amount as a selection criteria.

7. The method of claim 6, wherein if plurality of message contents has found to be associated with a content keyword that is the same than the matching content keyword and/or same than a content keyword in connection to the matching keyword, a message content having the highest bid amount of the plurality of the message contents is selected for delivery.

8. The method of claim 6, wherein if plurality of message contents has found to be associated with a content keyword that is the same than the matching content keyword and/or same than a content keyword in connection to the matching keyword, a message content having the lowest bid amount of the plurality of the message contents is selected for delivery.

9. The method of claim 6, wherein a message content having a bid amount has a set budget amount defining a fund amount.

10. The method of claim 9, wherein the fund amount is reduced by the set bid amount when the message content is selected for delivery.

11. The method of claim 9, wherein a message content is selected for delivery if remaining fund amount is bigger than the set bid amount.

12. The method of claim 9, wherein the set budget amount is a daily budget.

13. The method of claim 1, wherein if plurality of message contents has found to be associated with a content keyword that is the same than the matching content keyword and/or same than a content keyword in connection to the matching keyword, a message content having associated with the same content keyword than the matching keyword is selected for delivery.

14. The method of claim 1, wherein association of a message content with a content keyword is set during the process of uploading the message content to the content database.

15. The method of claim 1, wherein association of a message content with a content keyword is set during setting a campaign.

16. The method of claim 14, wherein association of a message content with a content keyword is done by selecting at least one content keyword from plurality of predetermined content keywords.

17. The method of claim 16, wherein the predetermined content keywords are arranged to a hierarchical structure to at least two levels.

18. The method of claim 17, wherein the hierarchical structure is a hierarchical tree structure comprising at least one main level and at least one sub-level.

19. The method of claim 18, wherein a first content keyword is connected to a second content keyword when the first content keyword is subordinate of the second content keyword.

20. A system for selecting message content for a recipient based on a message received from the recipient, the system comprising:
receiving means for receiving a message from a recipient, the message comprising at least one term;
selecting means for selecting at least one of the terms in the message as a keyword;
a content keyword database comprising plurality of content keywords;
comparing means for comparing the selected keyword to content keywords in the content keyword database to select at least one content keyword matching to the selected keyword as a matching content keyword;
a content database comprising plurality of message contents of which at least one message content is associated with at least one content keyword;
searching means for searching if any message content stored to the content database has a content keyword associated with it that is same than the matching content keyword and/or same than a content keyword in connection to the matching keyword; and
selecting means for selecting for delivery to the recipient a message content of which associated content keyword is the same than the matching content keyword and/or same than a content keyword in connection to the matching keyword.

21. The system of claim 20, the system further comprising means to send the selected message content to the recipient as a message.

22. The system of claim 21, wherein the system is arranged to send the selected message to the recipient as a Short Messaging System (SMS) message.

23. The system of claim 21, wherein the system is arranged to send the selected message to the recipient as a Multimedia Messaging System (MMS) message

24. The system according to claim 20, wherein the message received from the recipient is received as a response to a question sent to the recipient.

25. The system of claim 20, wherein the system comprises means to store a set bid amount for at least some of the message contents, and the system is arranged to select a message content using the set bid amount as a selection criteria.

26. The system of claim 25, wherein the system is arranged to select for delivery a message content having the highest bid amount of the plurality of the message contents, if plurality of message contents has found to be associated with content keyword that is the same than the matching content keyword and/or same than a content keyword in connection to the matching keyword.

27. The system of claim 25, wherein the system is arranged to select for delivery a message content having the lowest bid amount of the plurality of the message contents, if plurality of message contents has found to be associated with content keyword that is the same than the matching content keyword and/or same than a content keyword in connection to the matching keyword.

28. The system of claim 20, wherein the system is arranged to select for delivery a message content having associated with the same content keyword than the matching keyword, if plurality of message contents has found to be associated with a content keyword that is the same than the matching content keyword and/or same than a content keyword in connection to the matching keyword.

29. The system of claim 20, wherein the system is arranged to enable setting of association of a message content with a content keyword during the process of uploading the message content to the content database.

30. The system of claim 20, wherein the system is arranged to enable setting of association of a message content with a content keyword during setting a campaign.

31. The system of claim 29, wherein the system further comprises means for association of a message content with a content keyword by selecting at least one content keyword from plurality of predetermined content keywords.

32. The system of claim 31, wherein the predetermined content keywords are arranged to a hierarchical structure to at least two levels.

33. The system of claim 32, wherein the hierarchical structure is a hierarchical tree structure comprising at least one main level and at least one sub-level.

34. The system of claim 33, wherein a first content keyword is connected to a second content keyword when the first content keyword is subordinate of the second content keyword.

35. A computer program product, or a suite of computer programs, embodied in a non-transitory computer readable medium, comprising a set of program instructions, wherein execution of said program instructions causes a computer, or a suite of computers, to:
receive a message from a recipient, the message comprising at least one term;
select at least one of the terms in the message as a keyword;
compare the selected keyword to content keywords in a content keyword database, the content keyword database comprising plurality of content keywords, to select at least one content keyword matching to the selected keyword as a matching content keyword;
search if any message content stored to a content database has a content keyword associated with it that is same than the matching content keyword and/or same than a content keyword in connection to the matching keyword, the content database comprising plurality of message contents of which at least one message content is associated with at least one content keyword; and
select for delivery to the recipient a message content of which associated content keyword is the same than the matching content keyword and/or same than a content keyword in connection to the matching keyword.
